(19) United States
(12) Patent Application Publication
(10) Pub. No.: US 2025/0148572 A1
(43) Pub. Date: May 8, 2025

(54) INPUT-DEPENDENT UNCORRELATED WEIGHTING METHOD

(71) Applicant: GWANGJU INSTITUTE OF SCIENCE AND TECHNOLOGY, Gwangju (KR)

(72) Inventors: Bochang MOON, Gwangju (KR); Jonghee BACK, Gwangju (KR)

(73) Assignee: GWANGJU INSTITUTE OF SCIENCE AND TECHNOLOGY, Gwangju (KR)

(21) Appl. No.: 18/790,290

(22) Filed: Jul. 31, 2024

(30) Foreign Application Priority Data
Nov. 8, 2023 (KR) 10-2023-0153803

(51) Int. Cl. G06T 5/60; G06T 5/70

(52) U.S. Cl. CPC G06T 5/60; G06T 5/70; G06T 2207/20192

(57) ABSTRACT

An input-dependent uncorrelated weighting method is provided. The input-dependent uncorrelated weighting method includes: receiving an independent image and a correlated image; calculating differences between pixel estimates at a center pixel and neighboring pixels in the independent image and the correlated image, and an input-dependent kernel; and generating a denoised output image using the denoised pixel estimate at the center pixel, wherein the input-dependent kernel may be calculated by assuming that a sub-averaged estimate for calculating the difference in at least one of the independent image and the correlated image has a symmetric distribution.

### CROSS REFERENCE TO RELATED APPLICATION

The present application claims priority to Korean Patent Application No. 10-2023-0153803, filed on Nov. 8, 2023, the entire contents of which is incorporated herein for all purposes by this reference.

### BACKGROUND

### Field

The present invention relates to an input-dependent uncorrelated weighting method.

### Description of the Related Art

Since Monte Carlo path tracing method is a technique that generates an image through a statistical method, there is a noise in the image.

To solve this problem, a denoising technique is one widely adopted option. It basically removes the noise at a specific pixel by applying appropriate weights to neighboring pixels and blending them.

In particular, various deep learning-based denoising techniques have been actively studied in recent years and have shown high performance.

Meanwhile, errors in rendered images may be classified into variance and bias, and existing denoising techniques have a fundamental problem of increasing bias to effectively reduce variance compared to a noisy image.

A noise may be removed without increasing bias through an input-independent weighting method. However, it does not effectively reduce variance because a noise in the noisy image is not taken into consideration.

Accordingly, the present invention proposes a method that is capable of effectively reducing variance through a weighting method that is input-dependent but satisfied with uncorrelatedness, compared to an input-independent weighting method that does not increase bias.

### SUMMARY

The present invention relates to an input-dependent uncorrelated weighting method that is capable of removing a noise inherent in an image.

More specifically, the present invention relates to an input-dependent uncorrelated weighting method that is capable of effectively reducing variance through a weighting method that is input-dependent but satisfied with uncorrelatedness, compared to an input-independent weighting method that does not increase bias.

Further, the present invention relates to an input-dependent uncorrelated weighting method, which is capable of designing various weights that are satisfied with uncorrelatedness.

To achieve the aforementioned objects, there is provided a method according to the present invention. The method may include: receiving an independent image and a correlated image; calculating differences between pixel estimates at a center pixel and neighboring pixels in the independent image and the correlated image, and an input-dependent kernel; and generating a denoised output image using the denoised pixel estimate at center pixel, in which the input-dependent kernel may be calculated by assuming that a sub-averaged estimate for calculating the difference in at least one of the independent image and the correlated image has a symmetric distribution.

Further, the denoised pixel estimate at the center pixel may be an unbiased estimate under the assumption that the sub-averaged estimate has a symmetric distribution.

Further, the input-dependent kernel may be defined as a function that is satisfied with the following equations,

$$k ( Δ {z}_{ci}^{1} + α , … , Δ {z}_{ci}^{B} + α ) = k ( Δ {z}_{ci}^{1} , … Δ {z}_{ci}^{B} )$$

$$k ( - Δ {z}_{ci}^{1} , … , - Δ {z}_{ci}^{B} ) = k ( Δ {z}_{ci}^{1} , … Δ {z}_{ci}^{B} ) ,$$

Here,
k: input-dependent kernel,
yᵢ, zᵢ: pixel estimate at i-th pixel in independent image y and correlated image z,
Δy_{ci}, Δz_{ci}: difference between pixel estimates at c-th pixel and i-th pixel (Δy_{ci}≡y_{c}−yᵢ, Δz_{ci}≡z_{c}−zᵢ),
Δz_{ci}^{j}: j-th sub-averaged estimate for Δz_{ci}, and
α: arbitrary value.

Further, in the calculation of the denoised pixel estimate at the center pixel, the denoised pixel estimate may be calculated using a difference between a c-th pixel estimate and an i-th pixel estimate in the independent image, a difference between a c-th pixel estimate and an i-th pixel estimate in the correlated image, and the input-dependent kernel, and the i-th pixel may be defined as a neighboring pixel centered at c-th pixel.

Further, the input-dependent kernel may assign a weight using an input estimate that follows a symmetric distribution.

Further, the input estimate may be a difference between the pixel estimates at a center pixel and a neighboring pixel in at least one of the independent image and the correlated image, and a data-dependent weight may be generated by using the input estimate.

Meanwhile, there is provided a program executed by one or more processes on an electronic device and capable of being stored on a computer-readable medium. The program may include instructions to perform: receiving an independent image and a correlated image; calculating differences between pixel estimates at a center pixel and neighboring pixels in the independent image and the correlated image, and an input-dependent kernel; and generating a denoised output image using the denoised pixel estimate at the center pixel, in which the input-dependent kernel may be calculated by assuming that a sub-averaged estimate for calculating the difference in at least one of the independent image and the correlated image has a symmetric distribution.

As described above, according to the input-dependent uncorrelated weighting method of the present invention, a denoised pixel estimate at a center pixel can be calculated using differences between pixel estimates at the center pixel and neighboring pixels in an independent image and a correlated image, and an input-dependent kernel after the independent image and the correlated image are received. In the present invention, an input-dependent kernel can be designed to effectively reduce variance without increasing bias, while not having a process of finding an optimal tradeoff between bias and variance.

Further, the input-dependent uncorrelated weighting method according to the present invention can generate a denoised output image using the denoised pixel estimate at the center pixel. In the present invention, the heterogeneous variance inherent in input images can be reduced, and excessive blurring on edges can be avoided.

As described above, the input-dependent uncorrelated weighting method according to the present invention can effectively reduce variance compared to an input-independent weighting method.

### BRIEF DESCRIPTION OF THE DRAWINGS

FIG. 1 is a conceptual view for describing a comparison of results of image denoising through different kernels.

FIG. 2 is a flowchart for describing an input-dependent uncorrelated weighting method according to the present invention.

FIGS. 3 and 4 are conceptual views for describing the input-dependent uncorrelated weighting method according to the present invention.

FIGS. 5 to 7B are conceptual views for describing results and effects of applying the method proposed in the present invention.

FIG. 8 is a block diagram illustrating a structure of a computing device performing an input-dependent uncorrelated weighting method according to the present invention.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements.

Singular expressions include plural expressions unless clearly described as different meanings in the context.

In the present application, it should be understood that the terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The present invention relates to an input-dependent uncorrelated weighting method that is capable of effectively reducing variance through a weighting method that is input-dependent but satisfied with uncorrelatedness, compared to an input-independent weighting method that does not increase bias.

First, with reference to [Equation 1] and [Equation 2] below, one embodiment of equations based on the input-dependent uncorrelated weighting method according to the present invention can be seen.

$${\hat{μ}}_{c} = {k}_{c} {y}_{c} + {\sum }_{i ∈ {Ω}_{c}} {k}_{i} {y}_{i} + {\sum }_{i ∈ {Ω}_{c}} {k}_{i} Δ {z}_{ci} , \qquad [ Equation 1 ]$$

[Equation 1] is an example of a combination function that receives an independent image y and a correlated image z as inputs and produces an output image \hat{μ} to estimate the ground truth u. Assuming that the two input images (independent image and correlated image) are independent of each other, an output estimate \hat{μ}_{c} at a center pixel c may be calculated using [Equation 1]. An i-th pixel may be defined as a neighboring pixel centered at the c-th pixel, and a set of neighboring pixels centered at the c-th pixel may be defined as Ω_{c}.

That is, with reference to [Equation 1], one embodiment of the method that may remove a noise while remaining unbiased can be seen.

Further, when a kernel k for denoising is uncorrelated with the inputs y and z (e.g., E [kᵢ Δz_{ci}]=E [kᵢ] E [Δz_{ci}] and E [kᵢyᵢ]=E [kᵢ] E [yᵢ]), the expected value of the denoised pixel estimate \hat{μ}c at the center pixel may be represented as in [Equation 2] below.

$$\begin{matrix}E [ \text{?} ] = E [ {k}_{c} ] E [ {y}_{c} ] + {\sum }_{i ∈ {Ω}_{c}} E [ \text{?} ] E [ {y}_{i} ] + {\sum }_{i ∈ {Ω}_{c}} E [ \text{?} ] E [ Δ {z}_{ci} ] \\ = E [ {k}_{c} ] {μ}_{c} + \text{?} E [ {k}_{i} ] {μ}_{i} + {\sum }_{i ∈ {Ω}_{c}} E [ {k}_{i} ] ( {μ}_{c} - \text{?} ) \\ = E [ {k}_{c} + {\sum }_{i ∈ {Ω}_{c}} {k}_{i} ] {μ}_{c} = {μ}_{c} .\end{matrix} \qquad [ Equation 2 ]$$

$$\text{?} \text{indicates text missing or illegible when filed}$$

The statistical independence, i.e., the kernel k independent of the inputs y and z, is a method to satisfy this uncorrelatedness condition. As an example of an input-independent kernel, a uniform kernel exists like k_{c}=kᵢ=1/(|Ω_{c}|+1), which treats pixel estimates equally.

A denoised pixel estimate generated using the uniform kernel is unbiased, but the kernel is not effective because there is no consideration of the heterogeneous characteristics of the noise (e.g., structural errors) in the correlated input z.

That is, in order to handle heterogeneous variance, a kernel needs to be provided that not only considers the inputs y and z but also makes its denoising ideally unbiased.

Accordingly, in the present invention, an input-dependent kernel may be designed to effectively reduce variance without increasing bias, while not having a process of finding an optimal tradeoff between bias and variance.

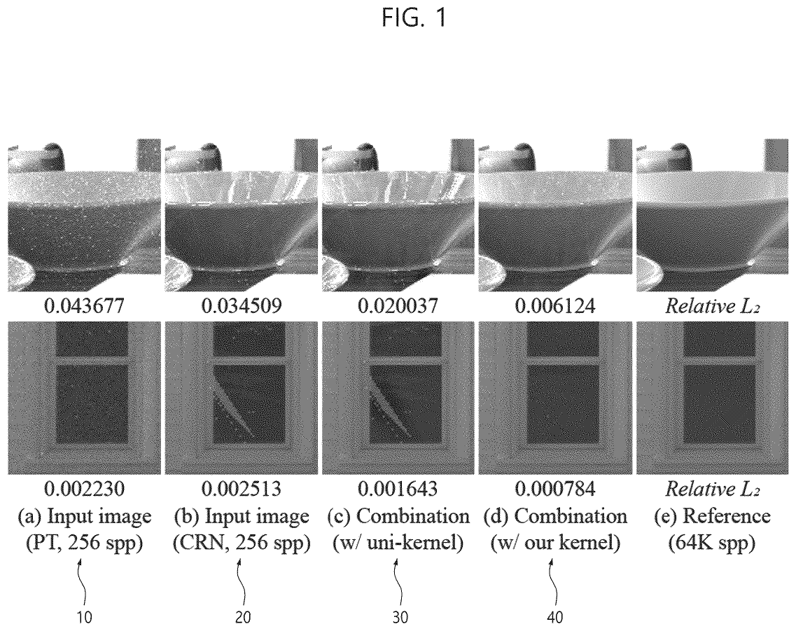

FIG. 1 is a conceptual view for describing a comparison of results of image denoising through different kernels.

With reference to FIG. 1, it can be seen that the uniform kernel may generate an unbiased image 30, but is not effective in reducing the heterogeneous variance inherent in a correlated image 20. In contrast, it can be seen that in the image 40 generated using the input-dependent kernel, the heterogeneous variance is reduced, and excessive blurring on edges across the image is avoided.

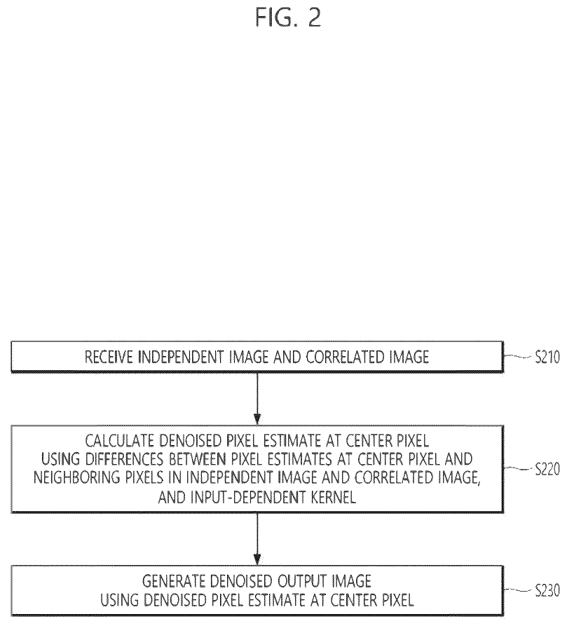

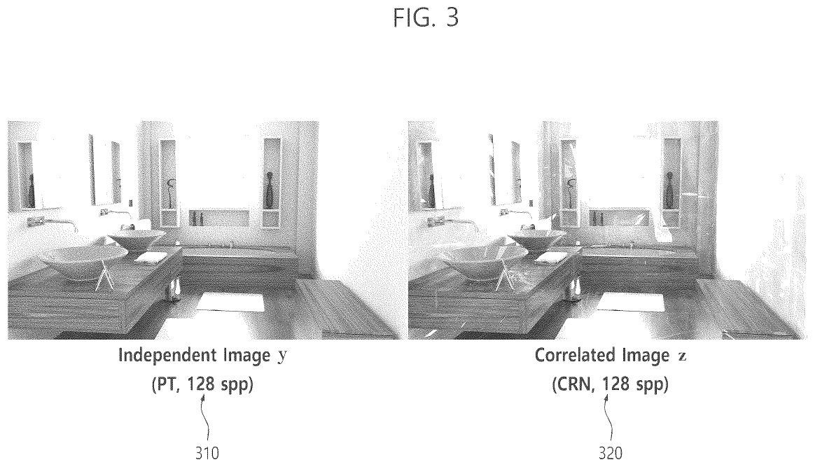

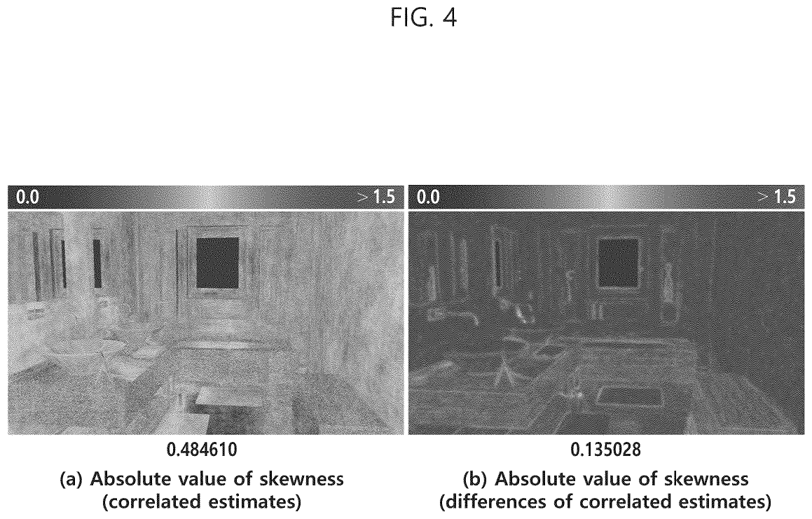

Hereinafter, an input-dependent uncorrelated weighting method according to the present invention will be described in more detail with reference to the accompanying drawings. FIG. 2 is a flowchart for describing an input-dependent uncorrelated weighting method according to the present invention. FIGS. 3 and 4 are conceptual views for describing the input-dependent uncorrelated weighting method according to the present invention.

In the present invention, a process of receiving an independent image and a correlated image may be executed (S210, see FIG. 2).

For example, as illustrated in FIG. 3, in the present invention, an independent image 310 and a correlated image 320 may be received as inputs.

Here, an independent image may be understood as an image in which pixel estimates are statistically uncorrelated and do not influence each other. In addition, a correlated image may be understood as an image in which pixel estimates are statistically correlated and influence each other.

Meanwhile, in the present invention, a process of calculating differences between pixel estimates at a center pixel and neighboring pixels in the independent image and the correlated image may be executed, and the denoised pixel estimate at the center pixel using the differences and an input-dependent kernel may be produced (S220, see FIG. 2).

In general, two random variables X and Y are uncorrelated when covariance is zero. That is, since cov(X, Y)=E[XY]−E[X]E[Y]=0, it can be said that there is no explicit dependency condition. Here, X and Y being independent means that there is no correlation, but X and Y being dependent does not necessarily mean that there is a correlation.

In the present invention, using the characteristics described above, a weight kᵢ may be defined that is dependent on but uncorrelated with an input Δz_{ci}, so that E[kᵢ Δz_{ci}]=E[kᵢ]E [Δz_{ci}] is satisfied. More specific details are described with reference to [Equation 3] and [Equation 4] below.

$$f ( {x}_{1} + α , {x}_{2} + \text{?} … , {x}_{n} + α ) = f ( {x}_{1} , {x}_{2} , … , {x}_{n} ) + α \text{?} \qquad [ Equation 3 ]$$

$$f ( - {x}_{1} , - {x}_{2} , … , - {x}_{n} ) = - f ( {x}_{1} , {x}_{2} , … , {x}_{n} ) ,$$

$$g ( {x}_{1} + α , {x}_{2} + α , … , {x}_{n} + α ) = g ( {x}_{1} , {x}_{2} , … , {x}_{n} ) , \qquad [ Equation 4 ]$$

$$g ( - {x}_{1} , - {x}_{2} , … , - {x}_{n} ) = g ( {x}_{1} , {x}_{2} , … , {x}_{n} ) \text{?}$$

$$\text{?} \text{indicates text missing or illegible when filed}$$

First, xᵢ, ∀ᵢϵ[1, n] is defined as a random sample drawn from a symmetric distribution, and n means the number of random samples. Further, f and g are functions of the random samples that are satisfied with [Equation 3] and [Equation 4], respectively. Here, a is an arbitrary value, and f (x₁, x₂, . . . , xₙ) and g (x₁, x₂, . . . , xₙ), which are the statistics of the different functions (f and g) respectively, may mean that there is no correlation.

That is, it is indicated that when the respective statistics generated by different functions f and g are satisfied with [Equation 3] and [Equation 4], there is no correlation.

Hereinafter, on the basis of [Equation 1] with the theory of uncorrelated statistics, it is described that image denoising via [Equation 1] is unbiased when the input-dependent kernel assigns weights using input estimates following the symmetric distribution.

First, in the present invention, k_{c}=1−Σ_{iϵΩ}_{_{c}}kᵢ may be inserted into [Equation 1] to convert [Equation 1] into a simplified version of the original combination. The converted version may be expressed as [Equation 5] below.

$${\hat{μ}}_{c} = {y}_{c} + {\sum }_{i ∈ {Ω}_{c}} {k}_{i} ( Δ {z}_{ci} - Δ {y}_{ci} ) , \qquad [ Equation 5 ]$$

In [Equation 5], Δy_{ci} may mean y_{c}−yᵢ, and Δz_{ci} may mean z_{c}−zᵢ. More specifically, Δy_{ci} may be understood as a difference between pixel estimates at the center pixel c and the neighboring pixel i in the independent image y, and Δz_{ci} may be understood as a difference between pixel estimates at the center pixel c and the neighboring pixel i in the correlated image z.

With reference to [Equation 5], a denoised pixel estimate \hat{μ}_{c} at the center pixel c may be calculated using differences between pixel estimates at the c-th pixel and the i-th pixel in the independent image y, differences between pixel estimates at the c-th pixel and the i-th pixel in the correlated image z, and an input-dependent kernel k. Here, the i-th pixel may be defined as a neighboring pixel centered at c-th pixel, and a set of neighboring pixels centered at c-th pixel may be defined as Ω_{c}.

Next, in the present invention, by using [Equation 3] and [Equation 4], a kernel function k may be designed to receive an input estimate Δz_{ci}, and a data-dependent weight kᵢ may be generated by using the input estimate.

Here, the input estimate Δz_{ci} may mean a difference between the pixel estimates at the center pixel and the neighboring pixel in the correlated image. In addition, the input estimate may mean a difference Δy_{ci} between the pixel estimates at the center pixel and the neighboring pixel in the independent image.

That is, the input estimate may be a difference between the pixel estimates at the center pixel and the neighboring pixel in at least one of the independent image and the correlated image, and the present invention is not limited thereto.

In the present invention, the input-dependent kernel may receive a sub-averaged estimate Δz_{ci}^{j} as input because individual samples are accessible in rendering. More specifically, in the present invention, B (B≥1) sub-averaged estimates Δz_{ci}^{j} of correlated samples, i.e., Δz_{ci}¹, . . . , Δz_{ci}^{B}, are introduced to make the input-dependent kernel k compatible with the rendering-specific data (i.e., the sub-averaged estimates). The sub-averaged estimates follow the same distribution D(μ_{c}−μᵢ, σ²/n), where σ² is variance of the correlated sample, and n means a sample size for each sub-average. Here, when B=1, it may be Δz_{ci}¹=Δz_{ci}.

The sub-averaged estimate Δz_{ci}^{j} may be generated by dividing individual samples into B separate sets for each pixel, and thus may be simply calculated in rendering

$$( that is , Δ {z}_{ci}^{j} = \frac{1}{n} {\sum }_{s = 1}^{n} Δ {z}_{ci , j \times n + s} ) .$$

Here, Δz_{ci,j×n+s} may be a (j×n+s)-th correlated sample for the estimate Δz_{ci}. In this case, the input estimate Δz_{ci} may be understood as an output value of the function f that takes an average of B sub-averaged estimates.

$$Δ {z}_{ci} = f ( Δ {z}_{ci}^{1} , … , Δ {z}_{ci}^{B} ) = \frac{1}{B} {\sum }_{j = 1}^{B} Δ \text{?} \qquad [ Equation 6 ]$$

$$\text{?} \text{indicates text missing or illegible when filed}$$

As in [Equation 6], it is notable that the defined function f has the properties previously described in [Equation 3].

Further, in the present invention, the input-dependent kernel k may be modeled as a function g in [Equation 4] above. It can be seen that the functions f and g are uncorrelated on the basis of [Equation 3] and [Equation 4]. In the present invention, a condition on the kernel k (or g) may be expressed by a new theorem, such as [Equation 7] below.

$$k ( Δ {z}_{ci}^{1} + α , … , Δ {z}_{ci}^{B} + α ) = k ( Δ {z}_{ci}^{1} , … Δ {z}_{ci}^{B} ) , \qquad [ Equation 7 ]$$

$$k ( - Δ {z}_{ci}^{1} , … , - Δ {z}_{ci}^{B} ) = k ( Δ {z}_{ci}^{1} , … Δ {z}_{ci}^{B} ) ,$$

The input-dependent kernel k is a function of Δz_{ci}^{j}, ∀jϵ[1, B], that is, k(Δz_{ci}¹, . . . , Δz_{ci}^{B}), which is satisfied with the following conditions.

With reference to [Equation 7], in the present invention, the input-dependent kernel k may be defined as a function that is satisfied with the following definitions:
k: Input-dependent kernel,
yᵢ, zᵢ: Pixel estimate at i-th pixel in independent image y and correlated image z,
Δy_{ci}, Δz_{ci}: Difference between pixel estimates at c-th pixel and i-th pixel (Δy_{ci}≡y_{c}−yᵢ, Δz_{ci}≡z_{c}−zᵢ), and
Δz_{ci}^{j}: j-th sub-averaged estimate for Δz_{ci}.

In [Equation 7], a may mean an arbitrary value. Assuming that the sub-averaged estimate Δz_{ci}^{j} has a symmetric distribution, the estimate \hat{μ}_{c} at the center pixel may be an unbiased estimate (that is, E[\hat{μ}_{c}]=μ_{c}).

That is, the input-dependent kernel k may be calculated by assuming that the sub-averaged estimate for calculating the difference between the pixel estimates in the correlated image has a symmetric distribution.

However, in the present invention, since the independent image may be received as well as the correlated image as input to the input-dependent kernel, the input-dependent kernel k may be calculated by assuming that the sub-averaged estimate for calculating the difference between the pixel estimates in at least one of the independent image and the correlated image has a symmetric distribution.

This [Equation 7] shows that noise removal without denoising bias can be achieved when the symmetric distribution condition is satisfied. Accordingly, in the present invention, the input-dependent kernel k may also be set as a function of another input Δy_{ci} or the two inputs Δy_{ci} and Δz_{ci}.

The extent of bias varies depending on the degree of asymmetry, but in the rendering situation, since the sub-averaged estimate Δz_{ci}^{j} is generally less skewed, it is possible to reduce variance while introducing very little bias. That is, the main assumption in [Equation 7] is that the difference between correlated pixel estimates (e.g., Δz_{ci}^{j}) has a symmetric distribution, rather than the pixel estimates (e.g., zᵢ^{j}).

For example, as illustrated in FIG. 4A and FIG. 4B, the numbers indicated at the bottom of the drawings mean the averages for the visualized per-pixel skewness. It can be seen that the distribution of per-pixel correlated estimates is highly skewed, but the skewness tends to be spatially similar, leading to 3.6 times lower skewness for the difference.

In addition, according to the central limit theorem, the distribution of the sub-averaged estimate Δz_{ci}^{j} may converge to a symmetric distribution as the sample size approaches infinity. These properties may make denoising using the input-dependent kernel k consistent.

As described above, in the present invention, [Equation 7] may be used as a new method for denoising an image.

Meanwhile, in the present invention, a process of generating a denoised output image using the denoised pixel estimate at the center pixel may be executed (S230, see FIG. 2).

While [Equation 7] above enables a wide range of designs of the unbiased input-dependent kernel k, in the present invention, a simple variance-based weighting with B=2 is selected as a proof of concept. Such an equation may be expressed as [Equation 8] below.

$$k ( Δ {z}_{ci}^{1} , Δ {z}_{ci}^{2} ) = \frac{1}{\vert {Ω}_{c} \vert} exp ( - γ n {( Δ {z}_{ci}^{1} - Δ {z}_{ci}^{2} )}^{2} ) \text{?} \qquad [ Equation 8 ]$$

$$\text{?} \text{indicates text missing or illegible when filed}$$

[Equation 8] is satisfied with the conditions of [Equation 7], which are described above. γ may mean a scale parameter shared for all the center pixels c. Ω_{c} is set to 15×15, and the squared term (Δz_{ci}¹−Δz_{ci}²)² may serve as an estimated variance for Δz_{ci}. In the present invention, the denoised output image u may be generated from the inputs y and z by applying [Equation 5] with such an input-dependent kernel k.

That is, in the present invention, the output image \hat{μ} may be generated using the estimate \hat{μ}_{c} at the center pixel c and the input-dependent kernel k.

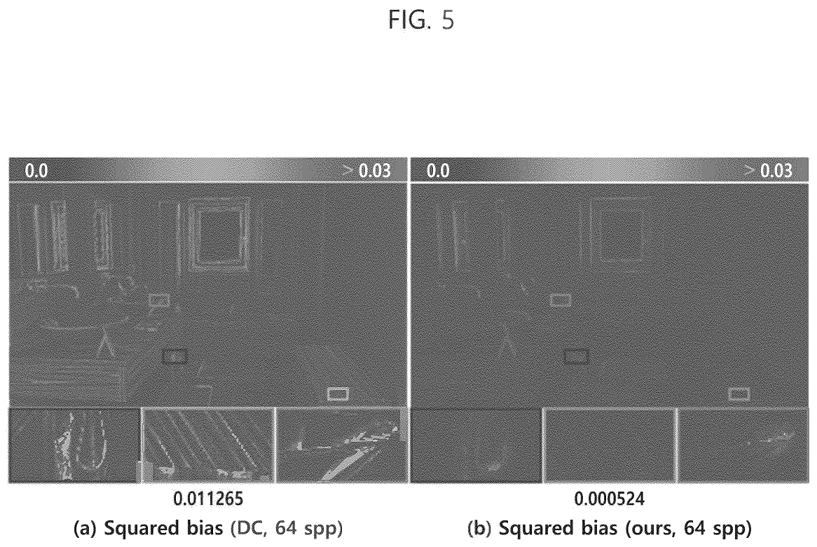

Hereinafter, with reference to FIGS. 5 to 7B, an example of results and effects of applying the method proposed by the present invention will be described more specifically.

As illustrated in FIG. 5A, it can be seen that the existing input-dependent kernel exhibits pronounced bias on the edges across the image. In contrast, it can be seen that the input-dependent kernel k designed in the present invention shows very little bias in the image, as illustrated in FIG. 5B. As a result, it can be seen that the input-dependent kernel has approximately 21 times less squared bias compared to the existing kernel, as indicated by the numbers at the bottom of the drawings.

That is, in the present invention, since the input-dependent kernel is designed to introduce an extremely small bias, which is only related to the skewness in the distribution of the input estimates, it can be seen to have a smaller bias than the existing kernel.

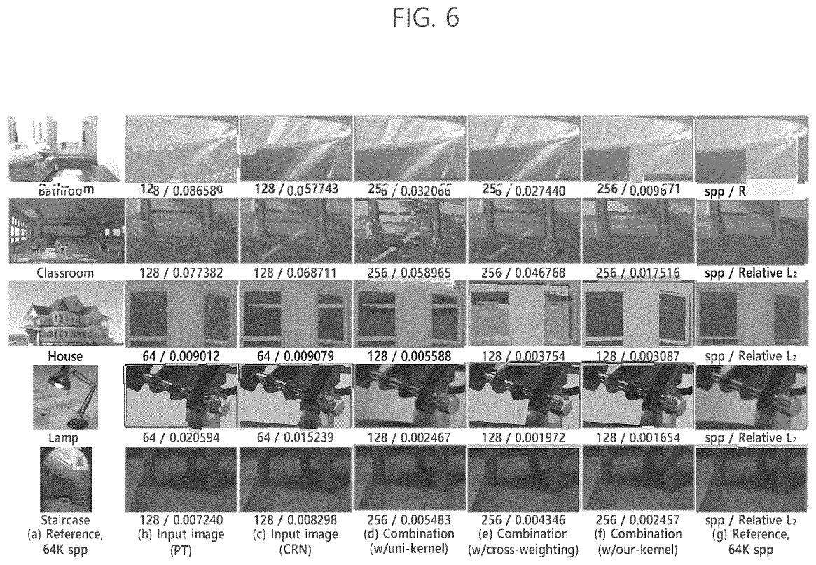

In addition, since the existing kernels illustrated in FIG. 6D and FIG. 6E are input-independent kernels that do not consider the heterogeneous errors in the input, the noise inherent in the input estimates (shown in FIG. 6B and FIG. 6C) is not effectively reduced. In contrast, it can be seen that the proposed input-dependent kernel illustrated in FIG. 6F is able to handle the heterogeneous errors inherent in the input estimates. This difference can also be confirmed by the numbers indicated at the bottom of the drawings.

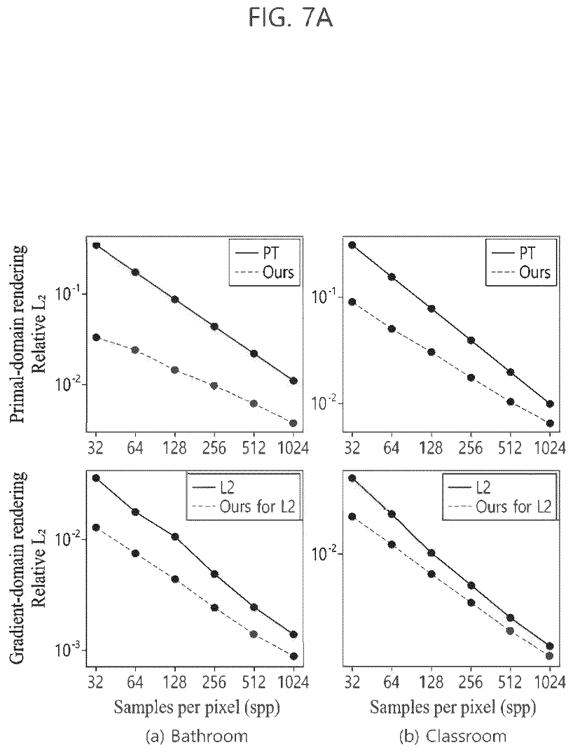

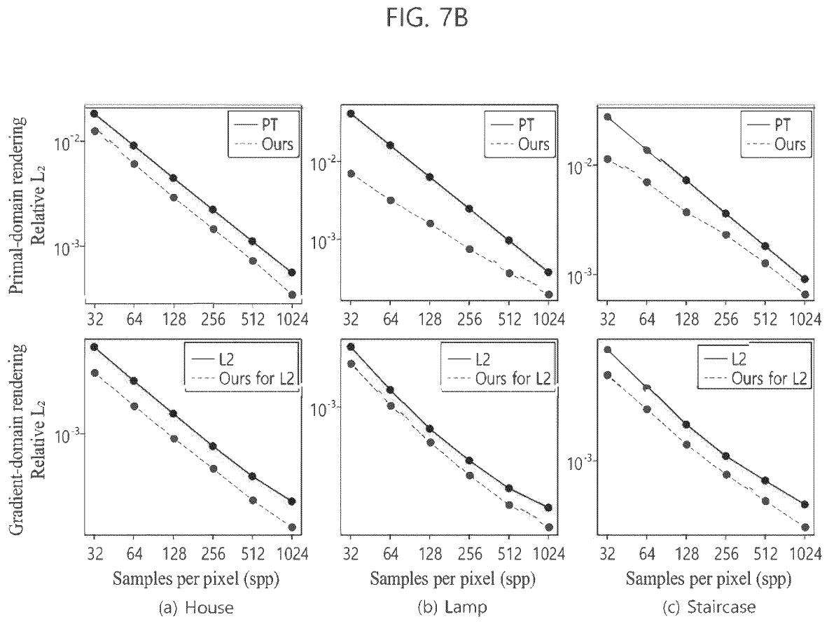

Further, with reference to the graphs illustrated in FIG. 7A and FIG. 7B, since the symmetry assumption is increasingly satisfied as the number of samples becomes infinite, it can be seen that the variance of the input estimates is reduced while restricting denoising bias that gradually decreases as the sample size increases.

That is, in the present invention, the errors of the input estimates may be reduced consistently across the sample sizes.

As described above, according to the input-dependent uncorrelated weighting method of the present invention, a denoised pixel estimate at a center pixel can be calculated using differences between pixel estimates at the center pixel and neighboring pixels in an independent image and a correlated image, and an input-dependent kernel after the independent image and the correlated image are received. In the present invention, an input-dependent kernel may be designed to effectively reduce variance without increasing bias, while not having a process of finding an optimal tradeoff between bias and variance.

Further, the input-dependent uncorrelated weighting method according to the present invention may generate a denoised output image using the denoised pixel estimate at the center pixel. In the present invention, the heterogeneous variance inherent in input images may be reduced, and excessive blurring on edges across the image may be prevented.

As described above, the input-dependent uncorrelated weighting method according to the present invention can effectively reduce variance compared to an input-independent weighting method.

Further, a system for performing the input-dependent uncorrelated weighting method according to the present invention may be constituted as a computing device to perform at least one function related to the aforementioned input-dependent uncorrelated weighting method.

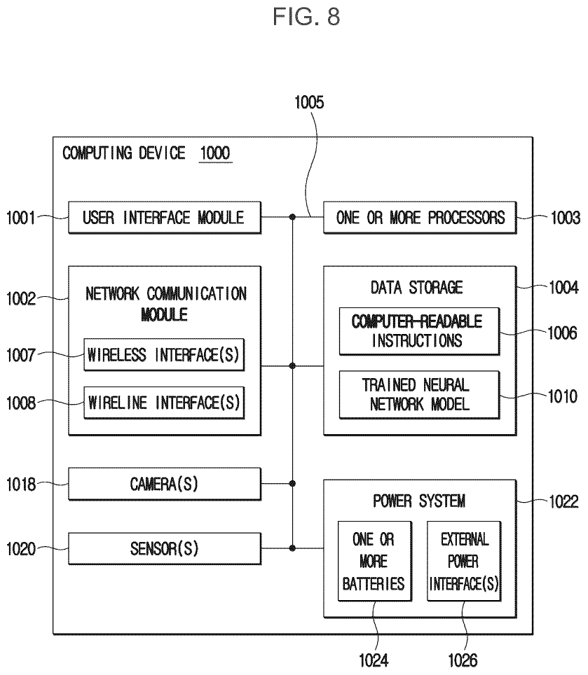

FIG. 8 is a block diagram illustrating a structure of a computing device performing the input-dependent uncorrelated weighting method according to the present invention.

A computing device 1000 may include a user interface module 1001, a network communication module 1002, one or more processors 1003, data storage 1004, one or more camera(s) 1018, one or more sensors 1020, and a power system 1022, all of which may be connected to each other through a system bus, network, or other connection mechanism 1005.

The user interface module 1001 may be operable to transmit data to an external user input/output device and/or receive data from the external user input/output device.

For example, in the present invention, receiving the independent image and the correlated image may be performed by external input using the user interface module. In this case, the user interface module 1001 may include a touch screen, a computer mouse, a keyboard, a keypad, a touch pad, a trackball, a joystick, a voice recognition module, or other similar devices.

In addition, the user interface module 1001 may also be constituted to provide output to a user display device, such as one or more cathode ray tubes (CRTs), a liquid crystal display, a light emitting diode (LED), a display using digital light processing (DLP) technology, or a printer.

The user interface module 1001 may also be constituted to generate audible output using a device such as a speaker, a speaker jack, an audio output port, an audio output device, earphones, and/or other similar devices.

The user interface module 1001 may further be constituted of one or more tactile devices that may generate a tactile output, such as a vibration and/or other output detectable by touch and/or physical contact with the computing device 1000.

The network communication module 1002 may include one or more devices providing one or more wireless interface(s) 1007 and/or one or more wireline interface(s) 1008 that may be constituted to communicate through a network.

In addition, the network communication module 1002 may be constituted to provide reliable security and/or authenticated communication.

The one or more processors 1003 may include one or more general-purpose processors and/or one or more special-purpose processors (e.g., a digital signal processor, a tensor processing unit (TPU), a graphics processing unit (GPU), a neural network processing unit (NPU), a custom integrated circuit, an application-specific integrated circuit (ASIC), and the like). The one or more processors 1003 may be constituted to execute computer-readable instructions 1006 included in the data storage 1004 and/or other instructions described in the present specification.

As such an example, an algorithm for calculating a denoised pixel estimate at a center pixel described in the present specification and an algorithm for removing noise using the denoised pixel estimate at the center pixel may be performed on a neural network processing unit (NPU) to increase efficiency by performing high-speed data calculation processing with low power.

The data storage 1004 may include one or more non-transitory computer-readable storage media that can be read and/or accessed by at least one of the one or more processors 1003.

The one or more computer-readable storage media may include volatile and/or non-volatile storage constituent elements, such as optical, magnetic, organic, or other memory or disk storage devices. In some examples, the data storage 1004 may be implemented using a single physical device (e.g., one optical, magnetic, organic, or other memory or disk storage device.) In contrast, in other examples, the data storage 1004 may be implemented using two or more physical devices.

The data storage 1004 may include the computer-readable instructions 1006 and additional data. The data storage 1004 may include storage necessary to perform at least some of the methods, scenarios, and techniques described in the present specification and/or at least some of the functions of the devices and networks.

The data storage 1004 may include, for example, storage for a neural network model 1010 to which the algorithm for calculating the denoised pixel estimate at the center pixel described in the present invention and the algorithm for removing noise using the denoised pixel estimate at the center pixel have been applied and which has been trained on the basis of the algorithms.

Meanwhile, the computing device 1000 may include one or more camera(s) 1018, one or more sensors 1020, and/or the power system 1022.

The camera(s) 1018 may capture light and/or electromagnetic radiation emitted as visible light, infrared radiation, ultraviolet light, and/or light of one or more other frequencies. The sensor 1020 may be constituted to measure conditions within the computing device 1000 and/or conditions in the environment of the computing device 1000 and provide data about those conditions. The power system 1022 may include one or more batteries 1024 and/or one or more external power interfaces 1026 for providing power to the computing device 1000.

Meanwhile, while the above has described that the system performing the input-dependent uncorrelated weighting method according to the present invention is implemented as a computing device, the present invention is not limited thereto. For example, the functions of the neural network and/or the computing device may be distributed among a plurality of computing clusters.

Meanwhile, the present invention described above may be executed by one or more processes on a computer and implemented as a program that can be stored on a computer-readable medium (or recording medium).

Further, the present invention described above may be implemented as computer-readable code or instructions on a medium in which a program is recorded. That is, the present invention may be provided in the form of a program.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present disclosure should be determined based on the reasonable interpretation of the appended claims, and all of the modifications within the equivalent scope of the present disclosure belong to the scope of the present disclosure.

What is claimed is:

1. An input-dependent uncorrelated weighting method comprising:
receiving an independent image and a correlated image;
calculating differences between pixel estimates at a center pixel and neighboring pixels in the independent image and the correlated image, and an input-dependent kernel; and
generating a denoised output image using the denoised pixel estimate at the center pixel,
wherein the input-dependent kernel is calculated by assuming that a sub-averaged estimate for calculating the difference in at least one of the independent image and the correlated image has a symmetric distribution.

2. The input-dependent uncorrelated weighting method of claim 1, wherein the denoised pixel estimate at the center pixel is an unbiased estimate under the assumption that the sub-averaged estimate has a symmetric distribution.

3. The input-dependent uncorrelated weighting method of claim 2, wherein the input-dependent kernel is defined as a function that is satisfied with the following equations,
$$k ( Δ {z}_{ci}^{1} + α , … , Δ {z}_{ci}^{B} + α ) = k ( Δ {z}_{ci}^{1} , … Δ {z}_{ci}^{B} )$$
$$k ( - Δ {z}_{ci}^{1} , … , - Δ {z}_{ci}^{B} ) = k ( Δ {z}_{ci}^{1} , … Δ {z}_{ci}^{B} ) ,$$
wherein:
k: input-dependent kernel,
yᵢ, zᵢ: pixel estimate at i-th pixel in independent image y and correlated image z,
Δy_{ci}, Δz_{ci}: difference between pixel estimates at c-th pixel and i-th pixel (Δy_{ci}≡y_{c}−yᵢ,Δz_{ci}≡z_{c}−zᵢ),
Δz_{ci}^{j}: j-th sub-averaged estimate for Δz_{ci}, and
α: arbitrary value.

4. The input-dependent uncorrelated weighting method of claim 1, wherein in the calculation of the denoised pixel estimate at the center pixel, the denoised pixel estimate is calculated using a difference between a c-th pixel estimate and an i-th pixel estimate in the independent image, a difference between a c-th pixel estimate and an i-th pixel estimate in the correlated image, and the input-dependent kernel, and
wherein the i-th pixel is defined as a neighboring pixel centered at the c-th pixel.

5. The input-dependent uncorrelated weighting method of claim 1, wherein the input-dependent kernel assigns a weight using an input estimate that follows a symmetric distribution.

6. The input-dependent uncorrelated weighting method of claim 5, wherein the input estimate is a difference between the pixel estimates at a center pixel and a neighboring pixel in at least one of the independent image and the correlated image, and a data-dependent weight is generated by using the input estimate.

7. A program executed by one or more processes on an electronic device and capable of being stored on a computer-readable medium, the program comprising instructions to perform:
receiving an independent image and a correlated image;
calculating differences between pixel estimates at a center pixel and neighboring pixels in the independent image and the correlated image, and an input-dependent kernel; and
generating a denoised output image using the denoised pixel estimate at the center pixel,
wherein the input-dependent kernel is calculated by assuming that a sub-averaged estimate for calculating the difference in at least one of the independent image and the correlated image has a symmetric distribution.
